(19) United States
(12) Patent Application Publication
(10) Pub. No.: US 2005/0114826 A1
(43) Pub. Date: May 26, 2005

(54) Apparatus and method for self management of information technology component

(76) Inventor: Phil Barthram, Wiltshire (GB)

Correspondence Address: COOPER & DUNHAM, LLP, 1185 AVENUE OF THE AMERICAS, NEW YORK, NY, 10036, US

(21) Appl. No.: 10/887,653

(22) Filed: Jul. 9, 2004

Related U.S. Application Data
(60) Provisional application No. 60/486,793, filed on Jul. 11, 2003.

(51) Int. Cl. G06F 9/44

(52) U.S. Cl. 717/100

(57) ABSTRACT

A method for self management of a self-managing IT component is provided. The method includes performing self-healing of the self-managing IT component. The self-managing component monitors for problems or failures in the component, and repairs a detected problem or failure in the component.

### CROSS-REFERENCE TO RELATED APPLICATION

This application claims the benefit of commonly owned U.S. Provisional Application No. 60/486,793, filed Jul. 11, 2003 and entitled “SELF MANAGEMENT INCLUDING GENETIC SELF MANAGEMENT”.

### TECHNICAL FIELD

This application relates to information technology. In particular, the application relates to self management of an information technology component.

### DESCRIPTION OF RELATED ART

The behavior of conventional information technology components (such as networks, systems, servers, databases, other hardware components, operating systems, applications, middleware, agents, other software components, etc.) is traditionally hard-coded and/or controlled by configuration settings which are set during the initial install of the component. A conventional information technology component is unable to adapt to changes in its operating environment. In other words, the behavior of a conventional component is static. Configuration settings of a conventional component are usually changed through actions taken by an information technology administrator or an end user. When a change to the operating environment occurs, human intervention is needed for the conventional component to continue to work optimally, and resources of an enterprise (or other organization) are often suboptimally allocated and/or unnecessarily diverted for the purpose of reconfiguring the system.

### SUMMARY

This application describes methods and apparatuses for self management of an information technology (IT) component. In one embodiment, a self-managing IT component includes a self-install module, a self-maintenance module and a self-healing module. The self-install module deploys the self-managing component. The self-maintenance module maintains the self-managing component. The self-healing module monitors for problems or failures in the self-managing component, and repairs a detected problem or failure in the self-managing component.

The application also provides a method for self management of a self-managing IT component. In one embodiment, the method includes performing self-install of the self-managing component, performing self-maintenance of the self-managing component, and performing self-healing of the self-managing component.

A self-healing IT component, according to one embodiment, includes an integrity check module and a healer module. The integrity check module monitors for problems or failures in the self-healing component. The healer module repairs a detected problem or failure in the self-healing component.

A method for self-healing of a self-managing IT component can include monitoring by a self-managing component for problems or failures in the self-managing component, and repairing by the self-managing component of a detected problem or failure in the self-managing component.

An apparatus for genetic self management of an IT component is also described. In one embodiment, the apparatus includes a self-managing component and a genes file adapted to store behavioral configuration information for the self-managing component. When changes in an IT environment occur, the self-managing component retrieves behavioral information from the genes file and self adapts according to the retrieved behavioral information.

A method for genetic self management of an IT component can include storing behavioral configuration information for a self-managing component in a genes file, retrieving behavioral information from the genes file when changes in an IT environment occur, and self-adapting the self-managing component according to the retrieved behavioral information.

### BRIEF DESCRIPTION OF THE DRAWINGS

The features of the present application can be more readily understood from the following detailed description with reference to the accompanying drawings wherein:

FIG. 1 shows a schematic diagram of a self-managing IT component, in accordance with one embodiment of the present application;

FIG. 2 shows a flow chart of a process, according to one embodiment, for self management of a self-managing IT component;

FIG. 3 shows a schematic diagram of a self-healing IT component, according to one embodiment of the present application;

FIG. 4 shows a flow chart of a method for self-healing of a self-managing IT component, according to one embodiment;

FIG. 5 shows a schematic diagram of an apparatus for genetic self management of an IT component, according to one embodiment;

FIG. 6 shows a flow chart of a method for genetic self management of an IT component, according to an alternative embodiment; and

FIG. 7 shows a schematic representation of on-demand computing with the self-management tools of this application integrated therein, according to an exemplary embodiment.

### DETAILED DESCRIPTION

This application provides tools (in the form of methodologies, apparatus and systems) for self management of a self-managing information technology (IT) component. The tools may be embodied in one or more computer programs deployed or to be deployed on the self-managing IT component, and stored on a computer readable medium and/or transmitted via a computer network or other transmission medium.

The following exemplary embodiments are set forth to aid in an understanding of the subject matter of this disclosure, but are not intended, and should not be construed, to limit in any way the claims which follow thereafter. Therefore, while specific terminology is employed for the sake of clarity in describing some exemplary embodiments, the present disclosure is not intended to be limited to the specific terminology so selected, and it is to be understood that each specific element includes all technical equivalents which operate in a similar manner.

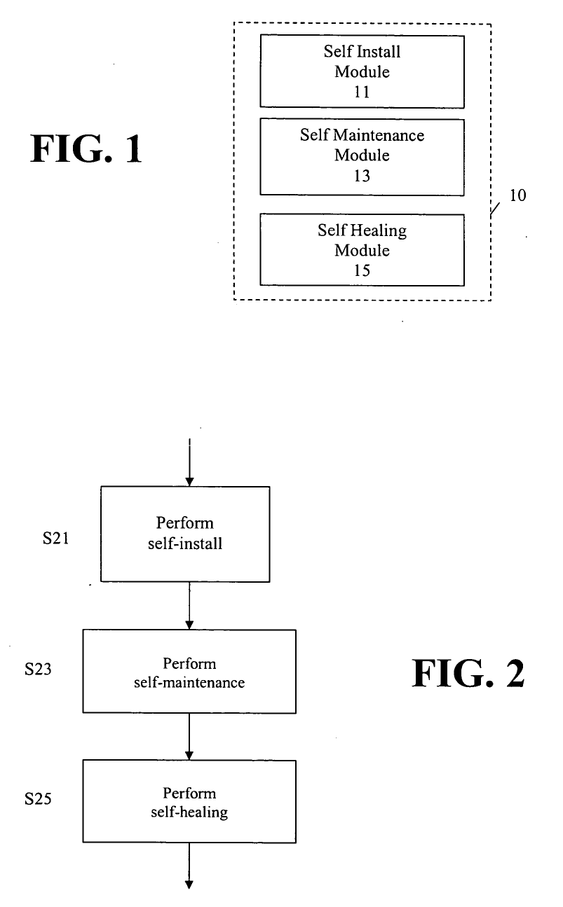

A self-managing component 10, according to one embodiment (FIG. 1), comprises a self-install module 11, a self-maintenance module 13 and a self-healing module 15. The self-install module 11 deploys the self-managing component 10. The self-maintenance module 13 maintains the self-managing component 10. The self-healing module 15 monitors for problems or failures in the self-managing component 10, and repairs a detected problem or failure in the self-managing component 10.

A method for self management of a self-managing IT component, according to one embodiment of the present application will be described with reference to FIGS. 1 and 2. The self-install module 11 performs self-install of the self-managing component 10 (step S21). The self-maintenance module 13 performs self-maintenance of the self-managing component 10 (step S23). The self-healing module 15 performs self-healing of the self-managing component (step S25).

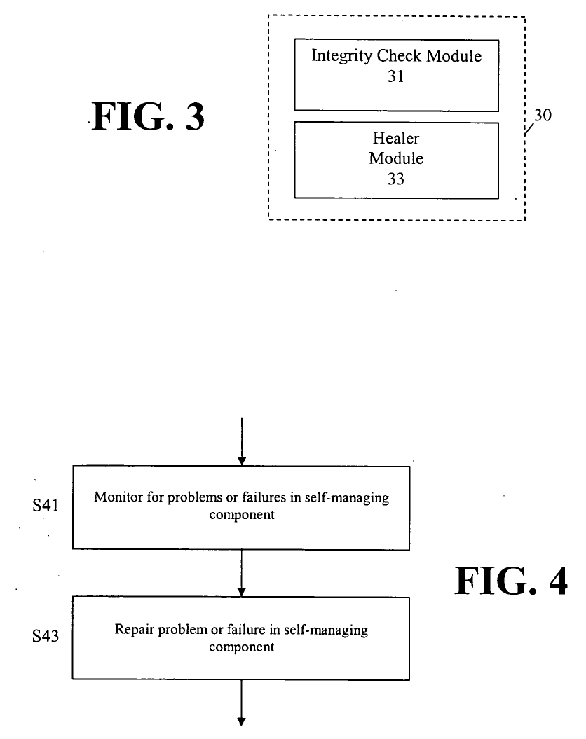

A self-healing IT component 30, according to one embodiment (FIG. 3), comprises an integrity check module 31 and a healer module 33. The integrity check module 31 monitors for problems or failures in the self-healing component 30. The healer module 33 repairs a detected problem or failure in the self-healing component 30.

A method for self-healing of a self-managing IT component, according to one embodiment of the present application, is shown in FIG. 4. The method includes monitoring by a self-managing component for problems or failures in the self-managing component (step S41), and repairing by the self-managing component of a detected problem or failure in the self-managing component (step S43).

The self management tools of this disclosure provide an IT component with the ability to adapt to changes in its environment without having to be re-configured by methods external to the component (such as reconfiguration initiated or activated by an administrator or another software component). The self-managing component essentially looks after itself. When changes in the component's environment occur, the component is able to automatically and autonomously decide how to adapt and continue to work optimally.

A self-managing component according to this disclosure is equipped with a set of capabilities which perform the actual adaptations to environmental change, without requiring hardcoding of various possible changes and corresponding desired reactions. A self managing component according to the present disclosure does not rely on static configuration, such as hardcoding of the address of a server or other features and properties which are enabled as needed. In the tools of this disclosure, the need for configuration settings is replaced with dynamic decision making methodologies.

A self managing infrastructure according to a preferred embodiment of the present application can include the following self-management features: self installation; self maintenance; self healing; and self adaptation. Performance and availability of an IT system can be improved through self-healing and self-maintenance of IT components. Further, self-management allows the IT infrastructure to function as a highly reliable utility.

In addition, a self managing infrastructure allows IT to be delivered as a service (for example, on-demand computing) driven directly by enterprise requirements. A self managing infrastructure can also support dynamic resource management, in which infrastructure resources, such as servers or network bandwidth, are dynamically optimized based on business priorities.

The ability of a self-managing component to self-install, self-maintain, self-heal and self-adapt, allows IT personnel to spend minimal time managing the IT system, and reduces IT costs. Operational tools that simplify analysis and automate functionality allow IT personnel to focus on more strategic infrastructure and service planning. A self-managing infrastructure shields IT staff from unnecessary complexity and allows the infrastructure to support the enterprise based on enterprise policies and priorities.

Self installation (also known as self deployment) involves the transfer, installation and initial configuration of software on an IT component without human intervention. The software deploys itself. Rules and intelligence may govern the automatic deployment. For example, agents associated with the self-managing component can be deployed, automatically registered with appropriate servers and placed in the proper computer group and address book to obtain the designated configuration and access permissions. In addition, the self-installation module may include one or more agents which are automatically dispatched to detect or determine parameters which define the operating environment in which the self-managing component is to be deployed. Thus, when the self-managing component to be installed is, for example, a staging server, the self-installation module of the staging server automatically locates the nearest local server, and registers the staging server with the local server. Pending jobs on the local server can be redirected to the staging server. In addition, the next time another nearby component attempts to connect to a server, an agent of the component detects the staging server and the component connects to the staging server. Agent technology is discussed, for example, in commonly-owned U.S. Pat. No. 6,327,550, which is incorporated in its entirety herein by reference.

Self maintenance can include two sub-categories, patching and housekeeping. Patching is the process by which software components keep themselves current. Patches, hot fixes and service packs can be downloaded and applied automatically. For example, patching may be performed to plug security vulnerabilities and/or correct bugs or defects in the software.

Housekeeping comprises background operations that ensure the smooth running of the self-managing component, preempting situations that might otherwise cause problems. For example, housekeeping may include deleting temporary files and obsolete references (for example, to a computer, a job, etc.) in a database or deallocating unused connections or memory.

A self-healing IT component fixes itself. The pre-cursor to self-healing operation is typically a condition (or set of conditions). Condition checking can be a substantially continuous process. When the condition is detected, an action can be invoked. Generally, the condition is a problem and the action is an operation that is intended to fix the problem. When a problem is detected, the self-managing component performs an appropriate operation to fix the problem. For example, self-healing may include detecting loop processes and then terminating the processes. Deployment of patches, fixes and service packs can be triggered by events or policy which once configured can be left alone.

Implementation of self-healing in some instances can be very similar to self maintenance, with a difference being the driving condition. In the case of self-healing, an existing problem causes software to be updated in an attempt to provide a solution. Self-maintenance is typically directed to forestalling development of new problems. The specific conditions and actions involved may vary considerably from one component to another component.

For example, a self-managing component may be connected to an appliance staging server. When the server goes down, the component, when attempting to run a job check, fails. The component automatically attempts (for example, through an agent) to locate another server. When another local server is found, the component connects to the local server to find a pending job to be executed.

Condition checking may include, for example, checking databases for consistency and analyzing links between tables. Missing links can be reported on and links to obsolete records can be removed automatically. The checking and repairing process can be scheduled to run on a regular basis.

Self adaptation is an ability of a self-managing component to modify (without human intervention) the parameters that determines its existence and behavior in order to continue functioning optimally after internal and external change. For example, a self-managing component may discover that one or more components it interoperates with is overloaded or has even failed. The self-managing component adapts to this situation by switching to other components that can serve its needs.

Some self-managing components may monitor their own footprints on the environment, and exercise automated throttling where appropriate. For example, wake-up and polling frequencies may be adjusted as appropriate (for example, according to system load). Repetitive, scheduled tasks may be staggered. Intensive network communications may be postponed to a time of low network communication.

The modifications are preferably policy and/or rules driven. For example, the policy may define a desired (or optimal) state, and the rules define a mechanism for modifying the parameters. A self-adaptation module selects and triggers the relevant rules, in order to conform with the defined policy.

The self-adaptation may monitor an operating environment, automatically learn the baseline behavior of the environment, and set threshold parameters of the self-managing component accordingly.

Self management is aided by access to information that is up-to-date and accurate. Typically, the information is from multiple sources. Auto-discovery enables the collection of information in a fast, accurate and automatic manner. Auto discovery is discussed in the following commonly-owned U.S. provisional applications, which are incorporated in their entireties herein by reference:
Ser. No. 60/486,317, filed Jul. 11, 2003 and entitled “MODELING OF APPLICATIONS AND BUSINESS PROCESS SERVICES THROUGH AUTO DISCOVERY ANALYSIS”;
Ser. No. 60/486,868, filed Jul. 11, 2003 and entitled “INFRASTRUCTURE AUTO DISCOVERY FROM BUSINESS PROCESS MODELS VIA BATCH PROCESSING FLOWS”;
Ser. No. 60/486,603, filed Jul. 11, 2003 and entitled “INFRASTRUCTURE AUTO DISCOVERY FROM BUSINESS PROCESS MODELS VIA MIDDLEWARE FLOWS”; and
Ser. No. 60/486,689, filed Jul. 11, 2003 and entitled “NETWORK DATA TRAFFIC AND PATTERN FLOWS ANALYSIS FOR AUTO DISCOVERY”.

As mentioned above, a self-managing component in many instances interoperates with other components, for example, to evaluate the available servers to determine the best choice. The best choice generally is a server which meets or even supersedes the self-managing component's needs, and thereby does not jeopardize interoperation with the other components in the network. If interoperation is optimized for such a server, the switch to the server does not jeopardize interoperation with the others.

Configuration data and performance data are typically used for the best choice determination. Performance data is mainly directed to performance of servers. In addition, data regarding network throughput between the interoperating components is also helpful. For example, the following performance data may be taken into consideration: average usage of memory, CPU (central processing unit), and disk space of the machine; average memory, CPU and disk usage caused by the service component; average response time of the service component to each of its clients; and average measure of the communication line throughput between two components. In addition, counts (such as “number of supported clients” and “max number of clients that can be supported”) may also affect the best choice. The objective of maintaining the counts is to allow the switch to a new server to be carried out in a balanced way. For instance, when a component experiences that its service component no longer responds in timely fashion, it can run a server evaluation in order to find a better choice. If there are many other components performing the same evaluation, they might each switch to the new server and thereby cause overload, while the old server becomes idle.

Performance data can be collected in an automated manner. Monitor tools can continuously provide information regarding average usage of system resources. Programs run on the servers, and report data to a central repository on a regular base. An evaluation tool evaluates the reported information, and condenses the data to high level information, such as using the counts discussed above. Communication line throughput can be measured on client machines. A monitoring tool measures the throughput to the server machines. High level performance data is used to control component interoperation in a balanced way. In a case of component overload or failure, an agent can be enabled to find another server that better meets requirements.

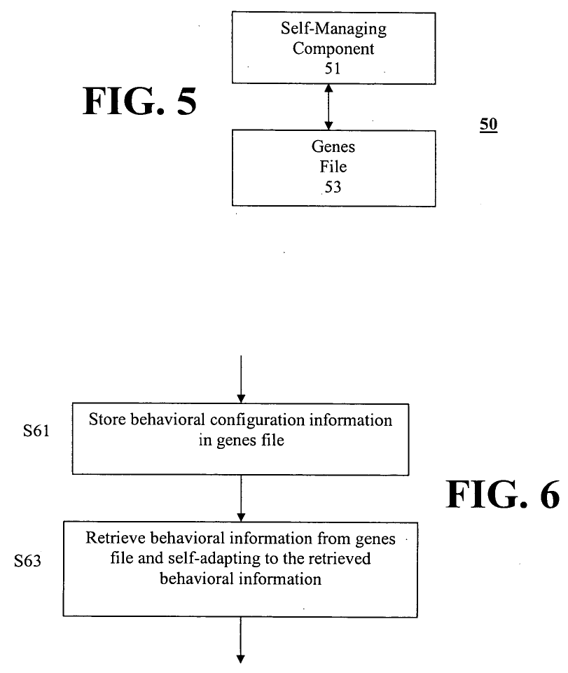

Self-management may include adjustments which are based on location. An exemplary embodiment of genetic self-management based on location is discussed below with reference to FIGS. 5 and 6. The behavioral configuration for a self-managing component is stored in a file and is referred to as software “genes” of the component. The self managing component adapts to changes and makes decisions based on its set of software genes. The behavior of the component is then decided by the genes. The behavior configuration, unlike conventional configuration settings, does not define specific actions in response to corresponding conditions. The genes define generally how the component behaves when encountering different situations. For example, the genes can broadly specify how the component reacts to change, in effect giving the component a sort of intelligence.

An apparatus for genetic self management of an IT component, according to one embodiment, is shown in FIG. 5. Apparatus 50 includes a self-managing component 51 and a genes file 53 adapted to store behavioral configuration information for the self-managing component. When changes in an IT environment occur, the self-managing component retrieves behavioral information from the genes file and self adapts according to the retrieved behavioral information.

A method for genetic self management of an IT component, according to one embodiment (FIG. 6), includes storing behavioral configuration information for a self-managing component in a genes file (step S61), retrieving behavioral information from the genes file when changes in an IT environment occur and self-adapting the self-managing component according to the retrieved behavioral information (step S63).

Genes may be component specific or generic. A generic gene controls the behavior of multiple components making behavioral configuration very easy.

Consider a scenario where two computers, a laptop and a desktop, are relocated from one location to another. In both locations there are servers running which are capable of serving the components running on the two computers. The server running in the original location is considered to be the home server of the two machines.

Using a traditional configuration based model, the behavior of a component is controlled by settings. The setting for the server address is static so regardless of location the component always connects to its home server, even though the computer on which the component is running may be re-located to the other side of the globe.

A self-managing component can be equipped to determine whether, when and where it has been relocated. Under the circumstance, a “roaming” gene, which defines the behavior of the component during roaming, suggests finding another server closer to its current location. When a server is found at the new location, the relocated desktop and laptop connect to it.

The component also consults its “loyalty” gene, which defines the behavior of the component when connecting to a new server, whether to make the new server its home server. The new server does not become its new home server immediately, since the roaming nature of the laptop suggests that it is likely that the laptop will roam back home. In the case of the desktop, the “loyalty” gene suggests making the new server its home server which leads to a move of all of the information related to the component from the previous server to its new home server.

Additional examples of genes are the “politeness” gene, which controls how much system resources a component consumes without disturbing the user of the computer or other running components or the “energy” gene that controls the behavior of the component when the computer runs on battery.

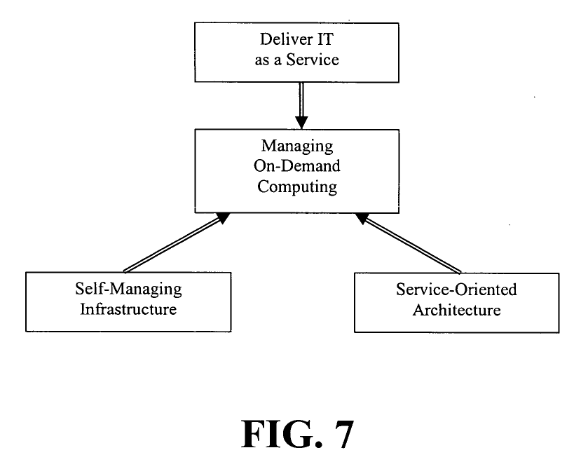

The self management tools of this disclosure have many applications. For example, the tools may be integrated in on-demand computing (FIG. 7).

The above specific embodiments are illustrative, and many variations can be introduced on these embodiments without departing from the spirit of the disclosure or from the scope of the appended claims. Elements and/or features of different illustrative embodiments may be combined with and/or substituted for each other within the scope of the disclosure and the appended claims.

For example, although an objective of self-management is to automate the management process, it should be apparent to one skilled in the art that the tools discussed in this disclosure may be adapted to provide capabilities for override of the automated control by an administrator and to allow the administrator to perform fine tuning if it is necessary to do so. In addition, although not specifically mentioned hereinabove, the automation discussed above may be coupled with automatically logging and documentation of actions taken in the self-management process.

Additional variations may be apparent to one of ordinary skill in the art from reading U.S. Provisional Application No. 60/486,793, filed Jul. 11, 2003, which is incorporated herein in its entirety by reference.

1. A method for self management of an IT component, comprising:
performing self-install of a self-managing component;
performing self-maintenance of the self-managing component; and
performing self-healing of the self-managing component.

2. The method of claim 1, further comprising:
detecting changes in an operating environment of the self-managing component; and
reconfigures the self-managing component according to the detected changes, without reconfiguration initiated or activated by an administrator or another software component.

3. The method of claim 1, further comprising:
detecting changes in an operating environment of the self-managing component; and
automatically and autonomously adapting the component in order for the component to continue to work optimally.

4. The method of claim 1, further comprising autonomously adapting the self-managing component based on enterprise policies and/or priorities.

5. The method of claim 1, further comprising automatically dispatching one or more agents to detect or determine parameters which define the operating environment in which the self-managing component is to be deployed.

6. The method of claim 1, further comprising autonomously detecting a problem in the self-managing component and performing an appropriate operation to fix the problem.

7. The method of claim 1, further comprising monitoring the self-managing component for problems and/or failures, and autonomously deploying patches and/or fixes which are triggered by detection of one or more of the problems and/or failures.

8. The method of claim 1, further comprising modifying the self-managing component, without human intervention.

9. The method of claim 1, further comprising detecting when one or more components with which the self-managing component interoperates is overloaded and/or has failed, and switching the self-managing component to other components that can serve the needs of the self-managing component.

10. The method of claim 1, further comprising monitoring a footprint of the self-managing component on an operating environment, and modifying the self-managing component accordingly.

11. The method of claim 1, further comprising monitoring an operating environment of the self-managing component to automatically learn the baseline behavior of the operating environment, and setting threshold parameters of the self-managing component accordingly.

12. A computer system, comprising:
a processor; and
a program storage device readable by the computer system, tangibly embodying a program of instructions executable by the processor to perform the method claimed in claim 1.

13. A program storage device readable by a machine, tangibly embodying a program of instructions executable by the machine to perform the method claimed in claim 1.

14. A computer data signal transmitted in one or more segments in a transmission medium which embodies instructions executable by a computer to perform the method claimed in claim 1.

15. A self-managing IT component, comprising:
a self-installation module adapted to deploy the self-managing component;
a self-maintenance module adapted to maintain the self-managing component; and
a self-healing module adapted to monitor for problems or failures in the self-managing component, and repair a detected problem or failure in the self-managing component.

16. The self-managing IT component of claim 15, further comprising a self-adaptation module, wherein the self-adaptation module reconfigures the self-managing IT component according to changes in an operating environment of the self-managing IT component, without reconfiguration initiated or activated by an administrator or another software component.

17. The self-managing IT component of claim 15, further comprising a self-adaptation module, wherein when changes in an operating environment of the self-managing IT component occur, the self-adaptation module automatically and autonomously adapts the component in order for the component to continue to work optimally.

18. The self-managing IT component of claim 15, further comprising a self-adaptation module, wherein the self-adaptation module autonomously adapts the self-managing IT component based on enterprise policies and/or priorities.

19. The self-managing IT component of claim 15, wherein the self-installation module includes one or more agents which are automatically dispatched to detect or determine parameters which define an operating environment in which the self-managing component is to be deployed.

20. The self-managing IT component of claim 15, wherein the self-maintenance module includes a patching submodule, and the patching submodule downloads and automatically applies patches to keep the self-managing IT component current.

21. The self-managing IT component of claim 15, wherein the patching submodule autonomously installs patches to plug security vulnerabilities and/or correct bugs or defects in the self-managing IT component.

22. The self-managing IT component of claim 15, wherein the self-maintenance module includes a housekeeping submodule, and the housekeeping submodule automatically performs background operations to ensure the smooth running of the self-managing component.

23. The self-managing IT component of claim 15, wherein the self-healing module autonomously detects a problem in the self-managing component and performs an appropriate operation to fix the problem.

24. The self-managing IT component of claim 15, wherein the self-healing module monitors the self-managing component for problems and/or failures, and autonomously deploys patches and/or fixes which are triggered by detection of one or more of the problems and/or failures.

25. The self-managing IT component of claim 15, further comprising a self-adaptation module, wherein the self-adaptation module modifies the self-managing IT component, without human intervention.

26. The self-managing IT component of claim 15, further comprising a self-adaptation module, wherein when one or more components with which the self-managing component interoperates is overloaded and/or has failed, the self-adaptation module switches to other components that can serve the needs of the self-managing component.

27. The self-managing IT component of claim 15, further comprising a self-adaptation module, wherein the self-adaptation module monitors a footprint of the self-managing component on an operating environment, and modifies the self-managing component accordingly.

28. The self-managing IT component of claim 15, further comprising a self-adaptation module, wherein the self-adaptation module monitors an operating environment of the self-managing component to automatically learn the baseline behavior of the operating environment, and sets threshold parameters of the self-managing component accordingly.

29. A method for self-healing of a self-managing IT component, comprising:
monitoring by a self-managing component for problems and/or failures in the self-managing component; and
repairing by the self-managing component of a detected problem and/or failure in the self-managing component.

30. A computer system, comprising:
a processor; and
a program storage device readable by the computer system, tangibly embodying a program of instructions executable by the processor to perform the method claimed in claim 6.

31. A program storage device readable by a machine, tangibly embodying a program of instructions executable by the machine to perform the method claimed in claim 6.

32. A computer data signal transmitted in one or more segments in a transmission medium which embodies instructions executable by a computer to perform the method claimed in claim 6.

33. A self-healing IT component, comprising:
an integrity check module adapted to self-monitor for problems or failures in the self-healing component; and
a healer module adapted to self-repair a detected problem or failure in the self-healing component.

34. A method for genetic self management of an IT component, comprising:
storing behavioral configuration information for a self-managing component in a genes file; and
retrieving behavioral information from the genes file when changes in an IT environment occur, and self-adapting the self-managing component according to the retrieved behavioral information.

35. The method of claim 34, further comprising:
detecting relocation of the self-managing component; and
controlling a behavior of the relocated component according to a roaming gene of the self-managing component.

36. The method of claim 34, further comprising:
detecting relocation of the self-managing component;
detecting a server in a closest proximity to the relocated component; and
determining whether to connect the relocated component to the closest server according to a loyalty gene of the self-managing component.

37. The method of claim 34, further comprising:
monitoring system resources consumed by the self-managing component; and
controlling a quantity of the system resources consumed by the self-managing component according to a politeness gene of the self-managing component.

38. The method of claim 34, further comprising:
monitoring whether the self-managing component is running on battery; and
controlling a behavior of the self-managing component according to an energy gene of the self-managing component, when the self-managing component is running on battery.

39. A computer system, comprising:
a processor; and
a program storage device readable by the computer system, tangibly embodying a program of instructions executable by the processor to perform the method claimed in claim 34.

40. A program storage device readable by a machine, tangibly embodying a program of instructions executable by the machine to perform the method claimed in claim 34.

41. A computer data signal transmitted in one or more segments in a transmission medium which embodies instructions executable by a computer to perform the method claimed in claim 34.

42. An apparatus for genetic self management of an IT component, comprising:
a self-managing component; and
a genes file adapted to store behavioral configuration information for the self-managing component,
wherein when changes in an IT environment occur, the self-managing component retrieves behavioral information from the genes file and self adapts according to the retrieved behavioral information.

43. The apparatus of claim 42, wherein the genes file includes genes specific to control of a behavior of the self-managing component.

44. The apparatus of claim 42, wherein the genes file includes one or more generic genes that control a behavior of one or more additional IT components.

45. The apparatus of claim 42, wherein the genes file of the self-managing component includes a roaming gene, and when relocation of the self-managing component is detected, a behavior of the relocated component is controlled according to the roaming gene.

46. The apparatus of claim 42, wherein the genes file of the self-managing component includes a loyalty gene, and when relocation of the self-managing component is detected, it is determined whether to connect the relocated component to a closest server according to the loyalty gene.

47. The apparatus of claim 42, wherein the genes file of the self-managing component includes a politeness gene, and a quantity of the system resources consumed by the self-managing component is controlled according to the politeness gene.

48. The apparatus of claim 42, wherein the genes file of the self-managing component includes an energy gene, and a behavior of the self-managing component is controlled according to an energy gene of the self-managing component, when the self-managing component is running on battery.
